(19) United States
(12) Patent Application Publication
(10) Pub. No.: US 2007/0226379 A1
(43) Pub. Date: Sep. 27, 2007

(54) Player with orientation-based controls

(75) Inventors: Yung-Fu Lin, Hsinchu (TW); Ray-Cheng Chang, Hsinchu (TW)

Correspondence Address: PATENTTM.US, P. O. BOX 82788, PORTLAND, OR, 97282-0788, US

(73) Assignee: Systrow Technology Corp.

(21) Appl. No.: 11/370,453

(22) Filed: Mar. 7, 2006

(51) Int. Cl. G06F 3/00

(52) U.S. Cl. 710/12; 710/301

(57) ABSTRACT

A player with orientation-based controls has a casing, a control unit, memory, an orientation-sensing module and a playing module. The casing has a front surface. The orientation-sensing module is mounted in the casing and has an orientation-sensing unit and a processing unit. The processing unit is connected to the control unit and the orientation-sensing unit. The playing module is mounted in the casing, is connected to the control unit and has an analog input interface, an audio decoding unit, a buffer, an amplifier, a speaker, a storage unit, a computer input/output (I/O) interface and a memory card I/O interface. The buffer is connected between the control unit and the audio decoding unit. The amplifier is connected to the analog input interface and the audio decoding unit. The speaker faces the front surface of the casing and is connected to the amplifier.

### BACKGROUND OF THE INVENTION

1. Field of the Invention

The present invention relates to a player, and more particularly to a player with orientation-based controls.

2. Description of Related Art

Players such as a radio, a Walkman, an MP3 player and the like are well known in the art. Most players have buttons to control the players by pressing appropriate buttons. However, buttons are not aesthetically pleasing.

To overcome the shortcomings, the present invention provides a player controlled by changing orientation of the player to mitigate or obviate the aforementioned problems.

### SUMMARY OF THE INVENTION

The main objective of the invention is to provide a player controlled by changing orientation of the player.

A player in accordance with the present invention comprises a casing, a control unit, memory, an orientation-sensing module and a playing module. The casing has multiple surfaces including a front surface that is perforated. The orientation-sensing module is mounted in the casing and comprises an orientation-sensing unit and a processing unit. The processing unit is connected to the control unit and the orientation-sensing unit. The playing module is mounted in the casing, is connected to the control unit and comprises an analog input interface, an audio decoding unit, a buffer, an amplifier, a speaker, a storage unit, a computer input/output (I/O) interface and a memory card I/O interface. The buffer is connected between the control unit and the audio decoding unit. The amplifier is connected to the analog input interface and the audio decoding unit. The speaker faces the front surface of the casing and is connected to the amplifier.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a player in accordance with the present invention;

FIG. 2 is a block diagram of the player in FIG. 1;

FIG. 3 is a perspective view of the player in FIG. 1 showing a rear surface of the player;

FIG. 4 is an operational perspective view of the player in FIG. 3 turned counterclockwise;

FIG. 5 is an operational perspective view of the player in FIG. 3 turned clockwise;

FIG. 6 is an operational perspective view of the player in FIG. 3 turned counterclockwise and then clockwise;

FIG. 7 is an operational perspective view of the player in FIG. 1 rotated clockwise; and

FIG. 8 is an operational perspective view of the player in FIG. 1 shaken.

### DETAILED DESCRIPTION OF PREFERRED EMBODIMENT

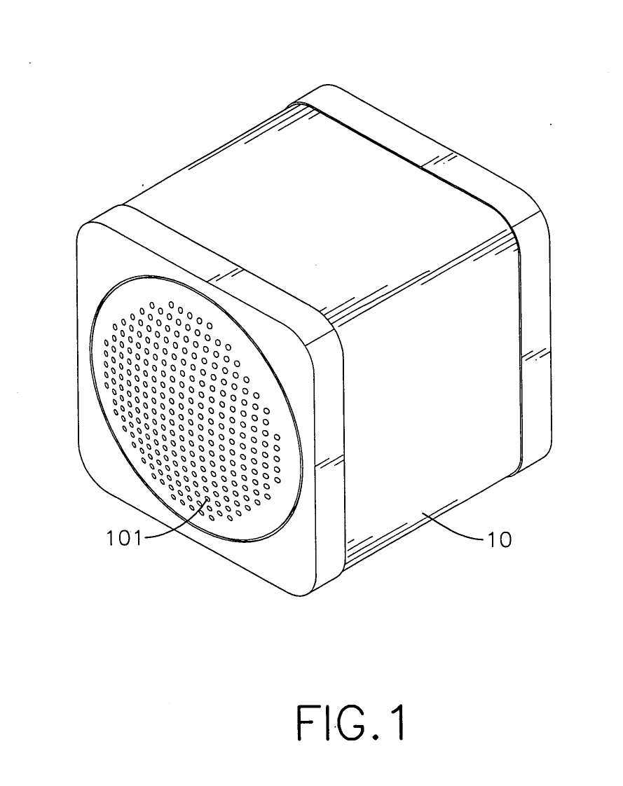

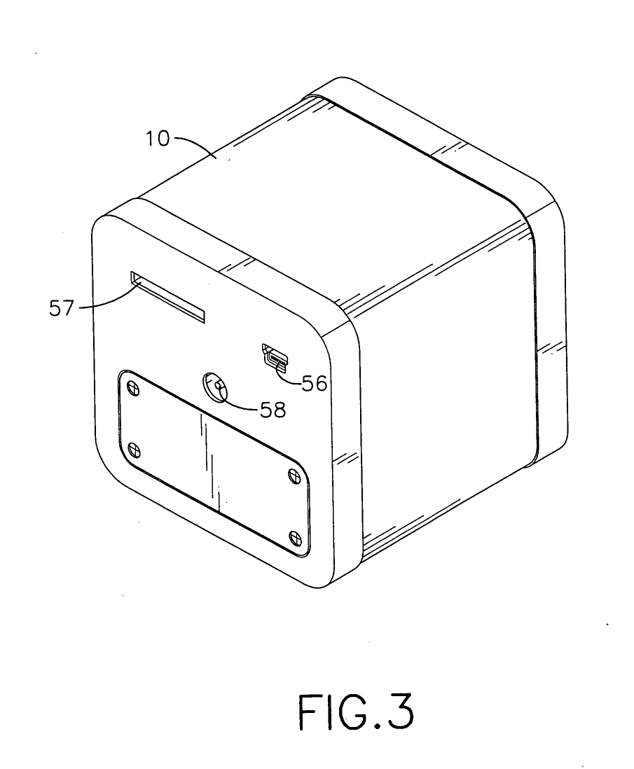

With reference to FIGS. 1 to 3, a player with orientation-based controls in accordance with the present invention is controlled by changing the orientation of the player and comprises a casing (10), a control unit (20), memory (30), an orientation-sensing module (40), a playing module (50) and an optional lighting module (60).

The casing (10) may be a hexahedron and has multiple surfaces including a front surface and a rear surface. The surfaces may be light-permeable. The front surface is perforated.

The control unit (20) is a processor mounted in the casing (10) to process digital data.

The memory (30) is mounted in the casing (10), is connected to the control unit (20) and may be a Static Random Access Memory (SRAM) chip.

The orientation-sensing module (40) is mounted in the casing (10) to sense orientation of the casing (10), is connected to and sends appropriate orientation signals to the control unit (20) and comprises an orientation-sensing unit (41), an optional vibration-sensing unit (42) and a processing unit (43).

The orientation-sensing unit (41) is mounted in the casing (10) to sense any change in orientation of the casing (10).

The optional vibration-sensing unit (42) is mounted in the casing (10) to sense any vibration of the casing (10).

The processing unit (43) is mounted in the casing (10) and is connected to the control unit (20), the-sensing unit (41) and the vibration-sensing unit (42) to transform orientation of the casing (10) sensed by the orientation-sensing unit (41) and the vibration-sensing unit (42) to orientation signals and send the orientation signals to the control unit (20).

The playing module (50) is mounted in the casing (10), is connected to the control unit (20), is used to play music and comprises an analog input interface (58), an audio decoding unit (53), a buffer (55), an amplifier (51), a speaker (52), a storage unit (54), a computer input/output (I/O) interface (56) and a memory card I/O interface (57).

The analog input interface (58) is mounted in the casing (10) and is exposed through the rear surface of the casing (10) to input analog data.

The audio decoding unit (53) is mounted in the casing (10) to convert digital data to analog signals.

The buffer (55) is connected between the control unit (20) and the audio decoding unit (53) to temporarily store digital data and may be a Dynamic Random Access Memory (DRAM) chip or a Static Random Access Memory (SRAM) chip.

The amplifier (51) is connected to the analog input interface (58) and the audio decoding unit (53) to amplify the analog signal.

The speaker (52) is mounted in the casing (10), faces the front surface of the casing (10) and is connected to the amplifier (51) to emit sound.

The storage unit (54) is connected to the control unit (20) and may be a NAND flash memory to store digital data.

The computer I/O interface (56) is connected to the control unit (20), is exposed through the rear surface of the casing (10) and may be a Universal Serial Bus (USB) I/O interface to connect to a computer device storing digital data.

The memory card I/O interface (57) is connected to the control unit (20), is exposed through the rear surface of the casing (10) and is used to connect to a memory card storing digital data.

The lighting module (60) is mounted in the casing (10), is connected to the control unit (20) and comprises multiple LEDs to emit light to provide decorative effects or indicate that the player is operating.

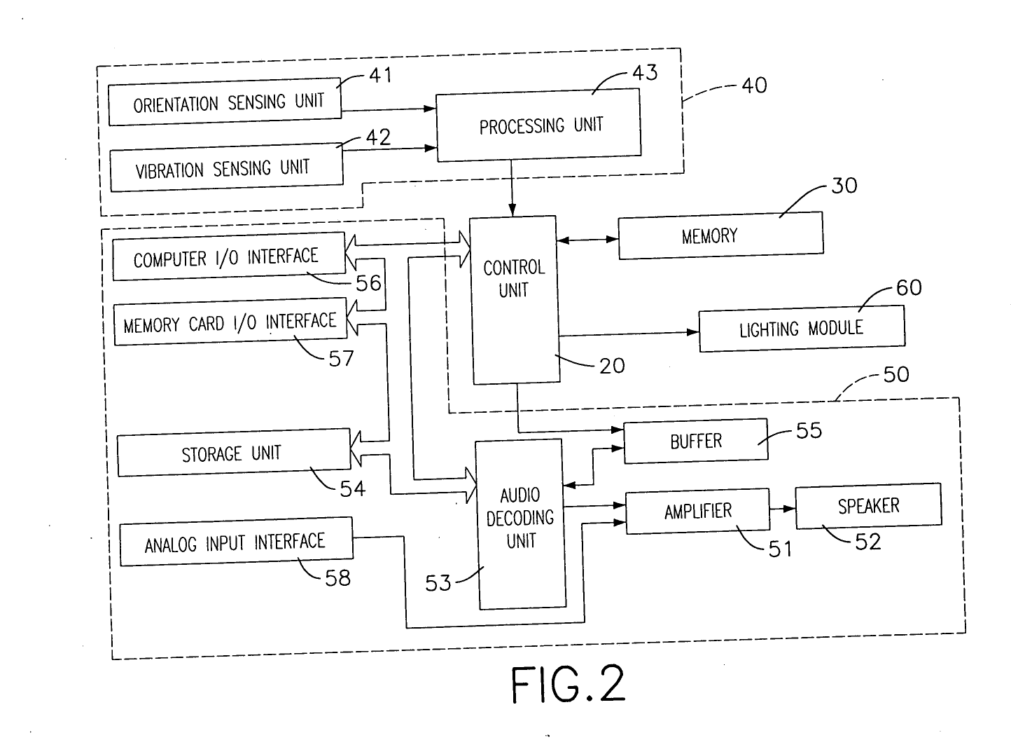

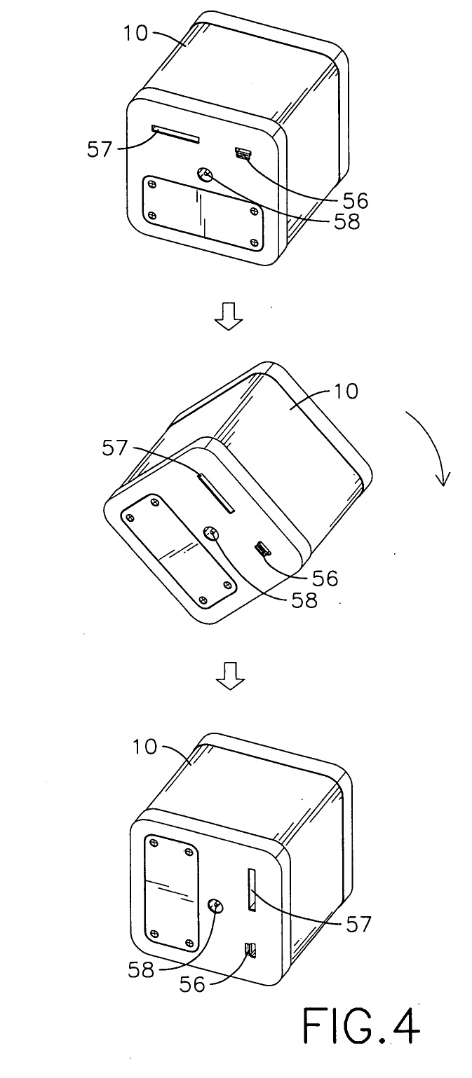

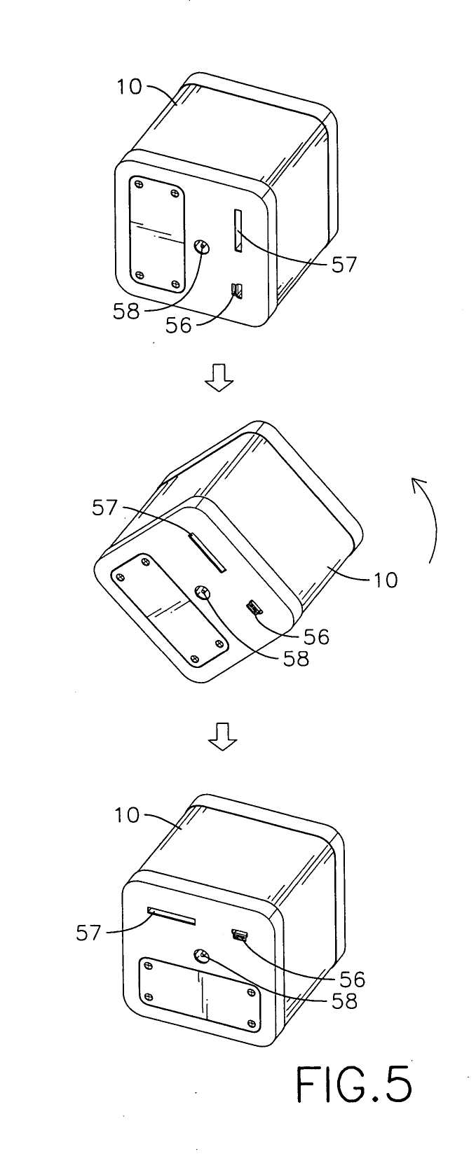

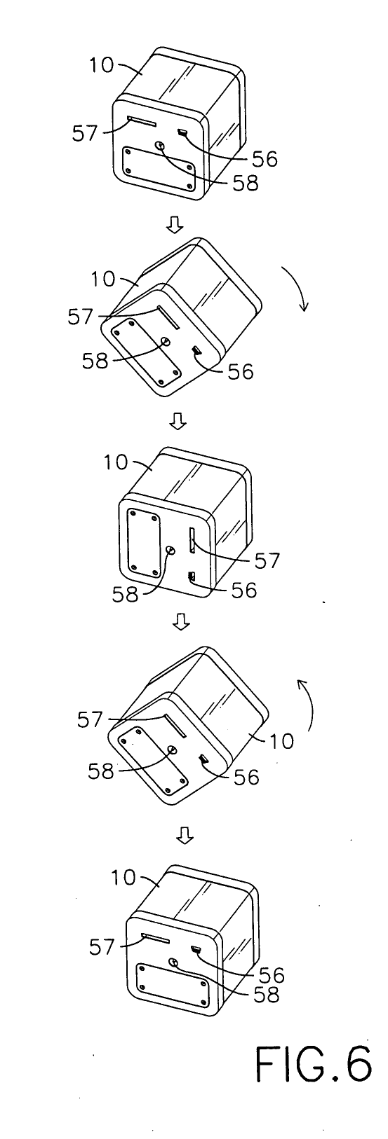

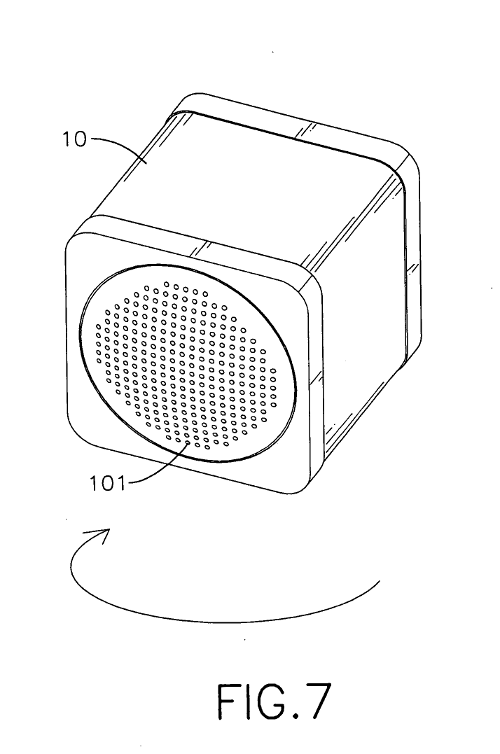

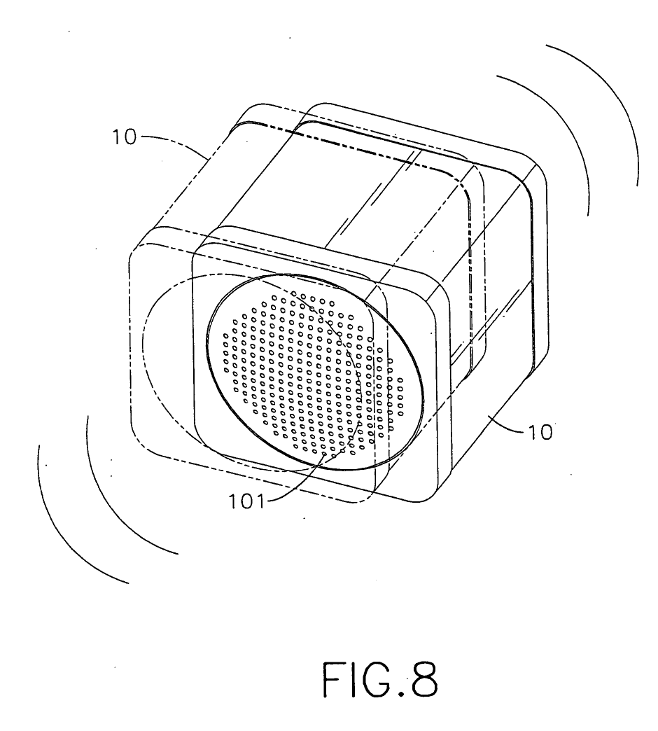

With reference to FIGS. 2 and 4 to 7, when the casing (10) is turned or rotated, the orientation-sensing unit (41) senses the change in orientation of the casing (10) and then the processing unit (43) notifies the control unit (20). Accordingly the control unit (20) commands the playing module (50) to play music. With further reference to FIG. 8, when the casing (10) is shaken, the vibration-sensing unit (42) senses the change in vibration of the casing (10), the processing unit (43) notifies the control unit (20), and the control unit (20) commands the lighting module (60) to emit lights.

Controlling such a player is easier and more fun than a conventional player, and the appearance of the player without buttons is aesthetically pleasing.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A player with orientation-based controls comprising:
a casing having multiple surfaces including
a front surface being perforated; and
a rear surface;
a control unit mounted in the casing;
memory mounted in the casing and connected to the control unit;
an orientation-sensing module mounted in the casing, connecting to the control unit and comprising
an orientation-sensing unit mounted in the casing; and
a processing unit mounted in the casing and connected to the control unit and the orientation-sensing unit; and
a playing module mounted in the casing, connected to the control unit and comprising
an analog input interface mounted in the casing and being exposed through the rear surface of the casing;
an audio decoding unit mounted in the casing;
a buffer connected between the control unit and the audio decoding unit;
an amplifier connected to the analog input interface and the audio decoding unit;
a speaker mounted in the casing, facing the front surface and being connected to the amplifier;
a storage unit being connected to the control unit;
a computer input/output (I/O) interface being connected to the control unit and being exposed through the rear surface of the casing; and
a memory card I/O interface being connected to the control unit and being exposed through the rear surface of the casing.

2. The player as claimed in claim 1, wherein the surfaces of the casing are light-permeable.

3. The player as claimed in claim 1, wherein the orientation-sensing module further comprises a vibration-sensing unit being mounted in the casing and connected to the processing unit.

4. The player as claimed in claim 1, wherein the buffer is a Dynamic Random Access Memory (DRAM) chip.

5. The player as claimed in claim 1, wherein the buffer is a Static Random Access Memory (SRAM) chip.

6. The player as claimed in claim 1, wherein the memory is a Static Random Access Memory (SRAM) chip.

7. The player as claimed in claim 1, wherein the storage unit is a NAND flash memory.

8. The player as claimed in claim 1, wherein the computer I/O interface is a Universal Serial Bus (USB) I/O interface.

9. The player as claimed in claim 2 further comprising a lighting module mounted in the casing, connected to the control unit and comprising multiple LEDs.
